(19) United States
(12) Patent Application Publication
(10) Pub. No.: US 2011/0048482 A1
(43) Pub. Date: Mar. 3, 2011

(54) SHADING SYSTEM

(76) Inventor: Emerson T. Yerian, Doylestown, OH (US)

(21) Appl. No.: 12/859,771

(22) Filed: Aug. 19, 2010

Related U.S. Application Data
(60) Provisional application No. 61/235,336, filed on Aug. 19, 2009.

(51) Int. Cl. E04H 15/40; E06B 9/24; B60J 3/02; E06B 9/42

(52) U.S. Cl. 135/125; 160/368.1; 160/127; 160/370.21

(57) ABSTRACT

A shade system that includes a shade assembly fixedly or non-fixedly attached to an extension component. The device has a first mounting component at a first end for holding the shade assembly and allows the shade assembly to be positioned in three dimensions in multiple orientations. The extension component has a second mounting component at a second end for attaching the extension component to a mounting surface.

### REFERENCE TO RELATED APPLICATION

This application claims priority to and the benefit of U.S. Provisional Application Serial No. 61/235,336 which was filed Aug. 19, 2009, entitled PORTABLE SHADING DEVICE FOR USE BY REAR SEAT PASSENGERS IN A VEHICLE, the entirety of which is hereby incorporated by reference as if fully set forth herein.

### BACKGROUND

The present invention is in the field of shade devices. More specifically this invention relates to shading devices for humans and/or animals for use in a car, a movable device, a stationary location or other location requiring shading.

There are many shading devices, for example, presently on the market for providing shade for passengers in the rear of a car, usually infants, children or pets. These devices generally focus on the light coming in through the side or rear windows of the vehicle. Such items include shading devices which are attached to the side or rear windows, such as with suction cups. Other devices are devices which go over an infant car seat to provide shade directly to the car seat passenger. However no items on the market address the issue of sunlight coming in through the front windshield, or through other windows and past the conventional shades attached to the window. That sunlight often gets directly in the front and/or rear seat passenger's eyes and/or makes a computer screen difficult to see in a vehicle, partially blinds people sitting outside and disturbs a babies eyes in a stroller, etc.

Therefore there is a need for an adjustable sun shade device which can shade individuals from sunlight entering vehicle windows, sunlight at a beach, etc.

### SUMMARY OF THE INVENTION

In one embodiment of the present invention, a shade system extension component is either fixedly or non-fixedly attached at a first end to a shade assembly by a first mounting component and either fixedly or non-fixedly attached at a second end to a mounting surface by a second mounting component.

In another embodiment of the present invention manual adjustment of the extension component allows the shade assembly to be positioned in multiple orientations with respect to three dimensions.

In another embodiment of the present invention a mounting surface can be a variety of locations and/or surfaces, such as a wheel chair arm, a vehicle window, a bicycle, a bicycle helmet, a patio chair, a patio table, a stroller frame, a sand beach chair, a stud wall, a ceiling, a floor, a weighted flexible stand, a chair inside a home, a structural support for a vehicle headrest, and the like.

In yet another embodiment of the present invention the first mounting component can be a ball and socket, a bracket with threaded fasteners, clips, a magnetic device, a hook and loop fastener, snaps, clamps and fittings or anything that one skilled in the art would use in mounting the shade system to the mounting surface.

In another embodiment of the present invention the extension component can be moved by a motor, a plurality of supporting devices, a spring wound device, an actuator, a gear assembly, a shape memory metal actuator, pneumatics, or hydraulics.

In yet another embodiment of the present invention an extension component can be flexible and/or rigid, where the extension component can be made of materials comprising metal, polymers and plastics.

In an embodiment of the present invention the extension component can have a hollow interior cavity that can be manufactured to allow materials comprising air, electrical wiring, and fiber optics to pass through the hollow channel.

Another embodiment of the present invention involves a shade assembly that can be made of materials comprising various films, frames, support structures and solar panel(s).

In yet another embodiment of the present invention the shade assembly can be any shape or adjustable into various shapes and sizes.

Yet another embodiment of the present invention involves fixedly or non-fixedly attaching film to a frame or mounting flexible film on a hanging device.

In yet another embodiment of the present invention, the shade system can utilize various electronic devices, software and hardware, controllers, and predetermined and/or desired factors to automatically reposition the shade assembly.

In yet another embodiment of the present invention the shading assembly can act as a TV screen, a computer screen, a monitor and a touch pad.

### BRIEF DESCRIPTION OF DRAWINGS

FIG. 1 is a perspective view of a shading system attached to a beach chair arm according to one aspect of the invention.

### DETAILED DESCRIPTION OF THE INVENTION

One or more implementations of the present invention will now be described with reference to the attached drawings, wherein like reference numerals are used to refer to like elements throughout. The invention relates to a shading system wherein an extension component is utilized to maneuver a shade assembly as necessary.

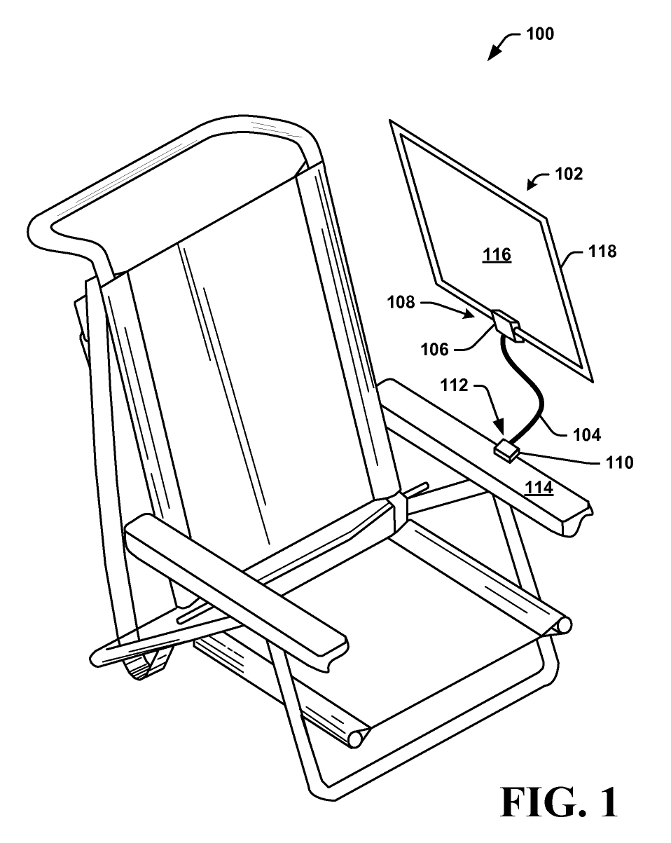

One embodiment of a shade system 100 is illustrated in FIG. 1. FIG. 1 is a front perspective view illustrating a beach chair and the shade system 100 that comprises a shade assembly 102 that is connected to an extension component 104. The shade assembly 102 is shown attached to the beach chair arm. A person sitting in the beach chair can be exposed to harsh sunlight and as the sun moves in the sky, the angle of the sun rays changes throughout the day. The shade assembly 102 can be adjusted as needed to compensate for the movement of the sun and the need of the person via a flexible extension component 104.

The extension component 104 is either fixedly or non-fixedly attached at a first end 108 to the shade assembly 102 by a first mounting component 106 and either fixedly or non-fixedly attached at a second end 112 to a second mounting component 114 by a second mounting component 110. The manual adjustment of the extension component 104 allows the shade assembly 102 to be positioned in multiple orientations with respect to three dimensions (x, y and z) known by those of skill in the art.

Even though the mounting surface 114 is pictured here as the beach chair arm it is apparent to one skilled in the art that the mounting surface can be a variety of locations and/or surfaces, such as a wheel chair arm, a vehicle window, a bicycle, a bicycle helmet, a patio chair, a patio table, a stroller frame, a sand beach chair, a stud wall, a ceiling, a floor, a weighted flexible stand, a chair inside a home, a structural support for a vehicle headrest, and the like.

The first mounting component 106 can be a ball and socket, a bracket with threaded fasteners, various clips, a magnetic device, a hook and loop fastener, snaps, clamps and fittings or anything that one skilled in the art would use in mounting the shade system 100 to the mounting surface 114.

The extension component 104 represented here can be moved by manual operation to readjust the location of the shade assembly 102. However, one skilled in the art can design numerous variations for the extension component 104 allowing it to be moved in other ways comprising motor actuation, a plurality of supporting devices, a spring motor, an actuator, a gear assembly, shape memory metal actuation, pneumatics, or hydraulics.

In addition, the extension component 104 can be flexible and/or rigid, wherein the extension component 104 can be made of materials comprising metal, polymers and plastics. In addition, an extension component 104 with a hollow interior cavity can be manufactured to allow materials comprising air, electrical wiring, and fiber optics to pass through the hollow channel. These flexible and/or rigid extension components are well known by those of skill in the art and all such embodiments are contemplated herein. The shade assembly 102 can be made with transparent polymeric film, solar panel(s) or anything one skilled in the art would use comprising an array of apertures through the retro-reflective film, heat-reflective material, a shade screen such that a vehicle driver can see through the shade component, vinyl perforated film, a photosensitive film which exhibits a change in optical density when an optical energy is applied to it, a non-translucent film, a tinted film, polymeric film, a multilayer unilateral see through film, a heat-reflective material, a light-reflective material, a cloth comprising metallic threads or a cloth shade.

The shade assembly 102 represented here is shown as a particular size and shape but the assembly 102 can be made in any shape or adjustable into shape and can be made any size or made to be adjustable in size. Allowing the shade assembly to be adjustable in size and shape gives flexibility to the user in choosing how much protection the shade assembly 102 provides. The various shapes can comprise rectangular shapes, oval shapes, octagons, circles and the like. The size of the shade assembly 102 can vary, for example a two by four inch shape to shapes measured in feet.

Here the shade component of the shade assembly 102 can be fixedly or non-fixedly attached to a frame structure 118. In another embodiment, the shade component of the shade assembly 102 can comprise being fixedly or non-fixedly attached to a horizontal or vertical component, for example a bar, to give structural support or the shade component can be rigid requiring no structural support. The techniques of fixedly or non-fixedly attaching film to a frame or mounting flexible film on a hanging device are well known by those of skill in the art.

In yet another embodiment of the present invention, the shade system 100 can utilize devices comprising light sensors, sensors, actuators, proximity sensors, software and hardware, controllers, GPS for the shade system 100 to control the positioning of the shade assembly 102. Based on the predetermined and/or desired factors comprising the UV index, the suns location determined by GPS, the vehicle location based on GPS, the sun location based on light sensors, and other sensor devices. This automatic repositioning would allow the user(s) to refrain from having to readjust the shade assembly 102 to block sunlight manually when there was a change in the position of the sun or a change in the position of the mounting surface 114.

The extension component 104 can comprise an adjustable shape-retaining element in a flexible covering, a joint member assembly, an adjustable arm assembly, an extendible arm cantilevered from a base support and a powered adjustable arm or anything one skilled in the art would use. In yet another embodiment, the shade assembly 102 can serve both as a shading device in addition perform functions comprising acting as a screen for a television, a computer screen, a monitor or a touch pad. In another embodiment, the extension component 104 (as mentioned supra) and/or the frame structure 118 can have holes in it allowing for air to pass through. This would allow the shade system 100 to act as a localized heating and/or air conditioning device and could use the existing vehicles air system.

Although the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

We claim:

1. A shade system comprising:
a shade assembly comprising a shading component and support structure;
a extension component; and
wherein the extension component has a first mounting component at a first end of the extension component for holding the shade assembly;
wherein the extension component allows the shade assembly to be positioned in three dimensional space in multiple orientations;
wherein the extension component has a second mounting component at a second end for attaching the extension component to a mounting surface.

2. The shade system of claim 1, wherein the mounting surface comprises a wheel chair arm, a vehicle window, a bicycle, a vehicle door, a bicycle helmet, a patio chair, a patio table, a stroller frame, a beach chair, a stud wall, a ceiling, a floor, a weighted stand, a weighted flexible stand, a chair inside a home and a structural support for a vehicle headrest.

3. The shade system of claim 1, wherein the shade assembly; is moved by devices comprising a motor, a plurality of supporting devices, a spring loaded device, an actuator, a gear assembly, manual operation, shape memory metal actuation, pneumatics, hydraulics, a passenger with a hand controller and a wired and/or wireless remote control.

4. The shade system of claim 1, wherein shade system utilizes devices comprising light sensors, sensors, actuators, proximity sensors, software and hardware, controllers, sensors, solar power, GPS for the system and/or the mounting surface to control the positioning of the shade assembly based on predetermined and/or desired factors comprising the UV index, the sun location determined by GPS, vehicle location based on GPS, the sun location base on light sensors, and sensors.

5. The shade system of claim 1, wherein the first mounting component comprises a ball and socket; a bracket with threaded fasteners, clips, magnetic devices, a hook and loop fastener, snaps, clamps and fittings.

6. The shade system of claim 1, wherein the shading component comprises a transparent polymeric film, an array of apertures through the retro-reflective film, a shade screen such that a vehicle driver can see through the shade component, vinyl perforated film, a photosensitive film which exhibits a change in optical density when an optical energy is applied to it, a non-translucent film, a tinted film, polymeric film, a multilayer unilateral see through film, a heat-reflective material, a light-reflective material, a cloth comprising metallic threads and a cloth shade.

7. The shade system of claim 1, wherein the shade assembly comprises the shading component fixedly or non-fixedly attached to a frame structure; wherein the shading component fixedly or non-fixedly attached to a horizontal component; and/or the shading component which is rigid requiring no structural support and/or frame.

8. The shade system of claim 1, wherein the extension component comprises an adjustable shape-retaining element in the flexible covering, a joint member assembly, one or multiple straight or flexible poles, an adjustable arm, an extendible arm cantilevered from a base support and a powered adjustable arm.

9. The shade system of claim 1, wherein the shading assembly comprises assemblies having shapes and sizing comprising adjustable sizes and shapes, fixed shapes, fixed sizes wherein the fixed shapes comprise rectangular shapes, oval shapes, octagons and circles.

10. The shade system of claim 1, wherein the shade system comprises a spring wound pull down shade assembly attached to the ceiling of a vehicle; wherein the bottom of the shade attaches to the back of a chair.

11. The shade system of claim 1, wherein the system is made of materials comprising metal, polymers, steel, aluminum, films and vinyl.

12. A shade system comprising:
an electrical system;
a shade assembly comprising a shading component with a structural support;
an extension component; and
wherein the extension component has a first mounting component at a first end for holding the shade assembly;
wherein the extension component allows the shade assembly to be positioned in three dimensions in multiple orientations;
wherein the extension component has a second mounting component at a second end for attaching the extension component to a mounting surface.

13. The shade system of claim 12, wherein the shade assembly can further act as a device that comprises a computer touch pad, a computer screen, a movie monitor, a radio and a television screen.

14. The shade system of claim 12, wherein the shade assembly can be moved to a desired location by techniques comprising a user operating a wired or wireless remote control, a shade system that utilizes devices comprising light sensors, sensors, actuators, proximity sensors, software and hardware, controllers, solar power, GPS for the system and/or the mounting surface to control the positioning of the shade assembly; based on predetermined and/or desired factors comprising the UV index, the sun location determined by GPS, vehicle location based on GPS, the sun location base on light sensors, and sensors.

15. The shade system of claim 12, wherein the shade assembly can comprise a frame with vent holes to provide air conditioned and/or heated air to a passenger in a car, can function as a solar collection panel, can provide lighting, can provide sound and/or music.

16. The shade system of claim 12, wherein the shade assembly comprises a tent like structure, a reconfigurable structure with one or more flexible poles that form arcs with a cross member that provides stability;
wherein the ends of the one or more flexible pole ends stuck in the sand, the ground and resting on asphalt;
wherein the two flexible poles hold the shade assembly either fixedly or non-fixedly.

17. The shade system of claim 12, wherein the shade assembly can provide components comprising a storage tray for writing instruments, a mirror and a toy holder.

18. The shade system of claim 12, wherein the shade assembly can be rolled up using techniques comprising a spring loaded device, a motor driven device and a manual wind-up device.

19. The shade system of claim 1, wherein the shade system is made of materials comprising metal, polymers, steel, aluminum, films and vinyl.

20. The shade system of claim 1, wherein the shade assembly is manufactured using techniques comprising molded construction having the shade molded directly to the frame and a shade non-fixedly attached to the support frame using hook and loop fasteners.
